(19) United States
(12) Patent Application Publication
(10) Pub. No.: US 2016/0179140 A1
(43) Pub. Date: Jun. 23, 2016

(54) Chassis Design for Wireless-Charging Coil Integration for Computing Systems

(71) Applicant: Intel Corporation, Santa Clara, CA (US)

(72) Inventors: Songnan Yang, San Jose, CA (US); Janardhan Narayan, Fremont, CA (US); Jonathan Rosenfeld, Portland, OR (US); Kerry Stevens, Beaverton, OR (US); Patrick Chewning, Beaverton, OR (US)

(21) Appl. No.: 14/672,169

(22) Filed: Mar. 28, 2015

Related U.S. Application Data
(63) Continuation-in-part of application No. 14/578,422, filed on Dec. 20, 2014.

(51) Int. Cl. G06F 1/16

(52) U.S. Cl. CPC G06F 1/1656

(57) ABSTRACT

This disclosure pertains to wireless-power transfer systems, and in particular (but not exclusively), to techniques to improve the coupling efficiency between a power transmitting unit and a power receiving unit within a computing system. The present disclosure includes a system which comprises a computing unit and a power transmitting unit adjacent thereto. The computing unit includes a system base, a conductive surface, and a power receiving unit. The conductive surface may have an opening that is adjacent to the power receiving unit and a slot extending from the opening towards the perimeter of the conductive surface. The system base may be coupled to the power receiving unit. The power receiving unit provides power to the system base.

### RELATED APPLICATION

This application claims the benefit of priority from U.S. Non-Prov. Pat. App. 14/578,422 filed 20 Dec. 2014, which is entirely incorporated by reference herein.

### FIELD

This disclosure pertains to wireless-power transfer systems, and in particular (but not exclusively), to techniques to improve the coupling efficiency between a power transmitting unit and a power receiving unit within a computing system.

### BRIEF DESCRIPTION OF THE DRAWINGS

To facilitate understanding, identical reference numerals have been used, where possible, to designate identical elements that are common to the drawings. The present disclosure may readily be understood by considering the following detailed description with the accompanying drawings which are not necessarily drawn to scale, in which:

FIG. 1 is an exemplary architecture of a wireless-power transfer system.

FIG. 2 is an exploded view of a computing system consistent with the present disclosure.

FIG. 3 is a top view of a power receiving unit (PRU) coil and a conductive surface disposed on a back cover of a computing system.

FIG. 4 is an exemplary illustration of a conductive surface within a computing system with eddy current(s) traversing along a perimeter of the conductive surface.

FIG. 5 is an exemplary illustration of the back of a computing system consistent with the present disclosure.

FIG. 6 is an illustration of a top portion of a computing system illustrating a coupling impedance and coupling efficiency profile between power transfer units (PTU) and PRU devices at various locations.

FIG. 7 illustrates the routing of electrostatic discharge (ESD) noise to ground within a computing system having an internal PRU/conductive surface unit.

### DETAILED DESCRIPTION

A detailed description of some embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to some embodiments have not been described in detail to avoid unnecessarily obscuring the description.

This disclosure pertains to wireless-power transfer systems, and in particular (but not exclusively), to techniques to improve the coupling efficiency between a power transmitting unit and a power receiving unit within a computing system. The present disclosure includes a system which comprises a computing unit and a power transmitting unit adjacent thereto. The computing unit includes a system base, a conductive surface, and a power receiving unit. The conductive surface may have an opening that is adjacent to the power receiving unit and a slot extending from the opening towards the perimeter of the conductive surface. The system base may be coupled to the power receiving unit. The power receiving unit provides power to the system base.

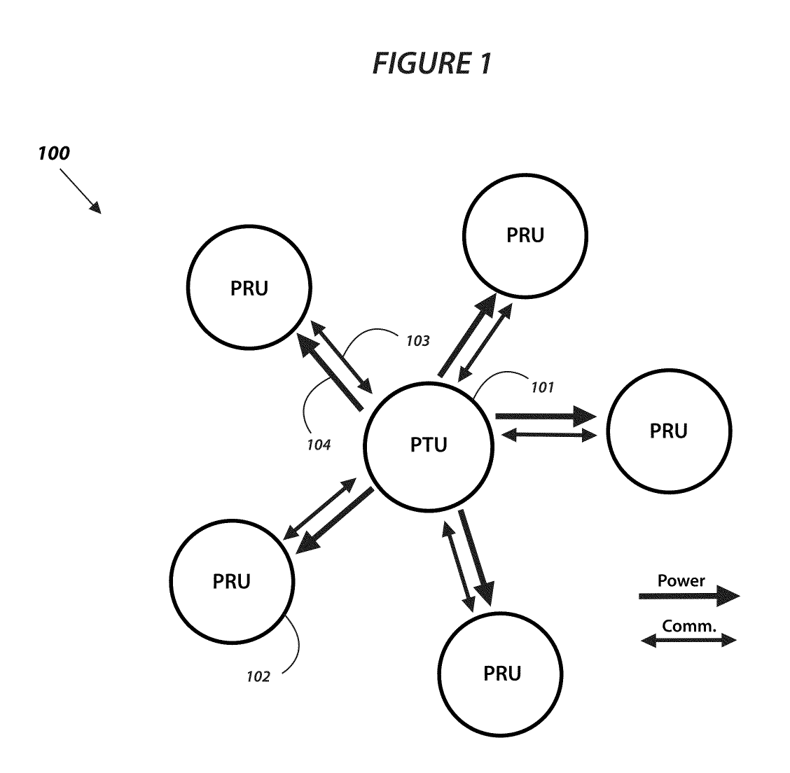

FIG. 1 is an exemplary architecture of a wireless-power transfer system 100. The wireless-power transfer system 100 shown includes a star topology with a power transfer unit (PTU) 101 and one or more power receiving units (PRU) 102. In operation, PTU 101 may exchange information (e.g., communication 103) with one or more PRUs 102. For example, PTU 101 may send network management information to the PRU devices 102, and in turn, the PRU devices may transmit its device information to PTU 101. In the embodiment shown, a single PRU device 102 may be integrated within a single computing system. However, in other implementations, more than one PRU device 102 may be integrated within a single computing system.

PTU 101 transfers power 104 to the PRU devices 102. In some implementations, PTU 101 transfers power to PRU devices 102 through a uniform coupling between PTU and PRU resonators over various positions. In some embodiments, this uniform coupling standardizes the electrical requirements among the PRU devices 102 and post-magnetic field uniformity requirements for PTU resonator designs. In some implementations, “coupling uniformity” may be defined as limiting the variance between the minimum and maximum magnetic field from 1:1 to 1:1.4.

A wireless-power transfer process consistent with the present disclosure may begin with configuring PTU 101 in a power save state. Next, utilizing a PTU resonator to generate short and long beacons, as required for load variation detection, to elicit a PRU device 102 response. Upon device detection, PTU 101 may transition to a low power state, establish a communication link with a PRU device 102, and exchange the necessary information for wireless power transfer. When PTU 101 is in a power transfer state, PTU 101 may configure the timing and sequence of the PRU devices 102.

Once the PTU and PRU devices have exchanged static information, PTU 101 may read a PRU dynamic parameter that provides measured parameters from the PRU devices 102. PTU 101 may then write a value to the PRU control such as the enable/disable charge and permission. In some embodiments, PTU 101 periodically reads the PRU dynamic parameter that contains the voltage, temperature, and current PRU status values, among others.

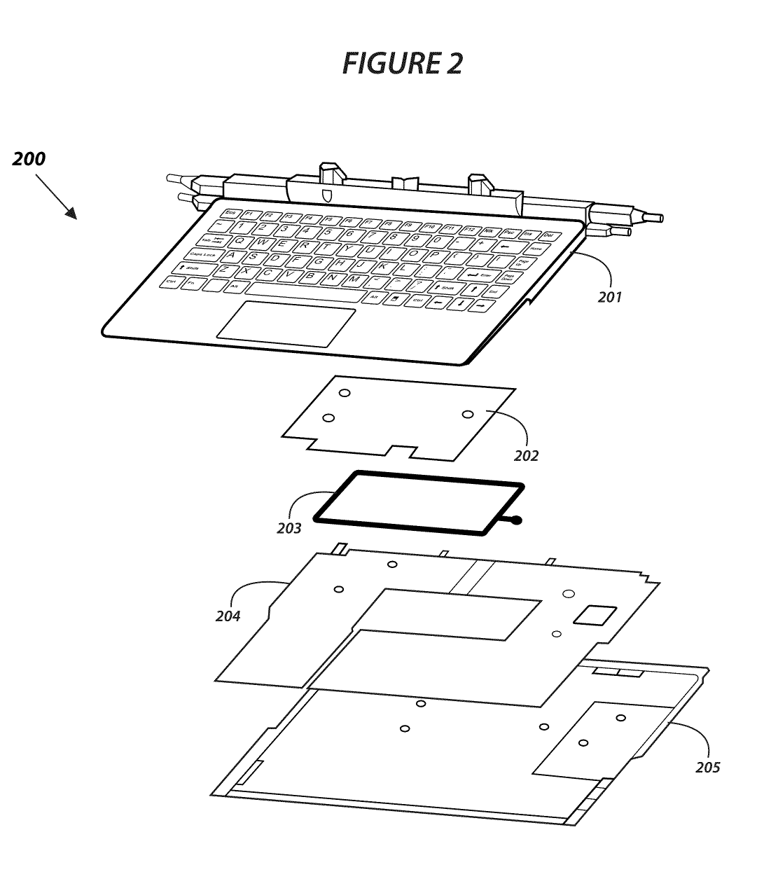

FIG. 2 is an exploded view of a computing system 200 consistent with the present disclosure. In FIG. 2, computing system 200 is an ultrabook computer which includes a system base 201, electromagnetic shield 202, PRU resonator 203, conductive surface 204, and back cover 205. Most notably, computing system 200 includes a novel conductive surface and a PRU assembly therein. Computing system 200 may include additional components than those disclosed so long as they do not cause the system 200 to deviate from the present disclosure of improving magnetic coupling between the PTU and PRU devices.

System base 201 may include a keyboard, touchpad, Ethernet port, display port, microphone-in jack, or speaker line-out jack. In FIG. 2, system base 201 includes a keyboard and touchpad. Electromagnetic shield 202 effectively prevents electromagnetic interference and electrostatic charges from reaching system base 201. In some embodiments, electromagnetic shield 202 comprises ferrite. PRU resonator 203 may include coils, with multiple turns, which magnetically couple with an external PTU device during a power transfer. Conductive surface 204 may have a body which extends towards the perimeter of back cover 205. In some embodiments, back cover 205 may be non-conductive.

The components of computing system 200 may be assembled in the order shown such that electromagnetic shield 202 is adjacent to system base 201 to divert incident magnetic fields from contacting component circuitry in the system base 201. Likewise, PRU resonator 203 may be adjacent to conductive surface 204 to effect magnetic coupling with an external PTU device and further shield unwanted magnetic fields from system base 201. Conductive surface 204 may be adjacent to back cover 205 to maximize magnetic coupling with an external PTU device without damaging the conductive surface 204 from ambient conditions (e.g., weather, external surfaces, etcetera).

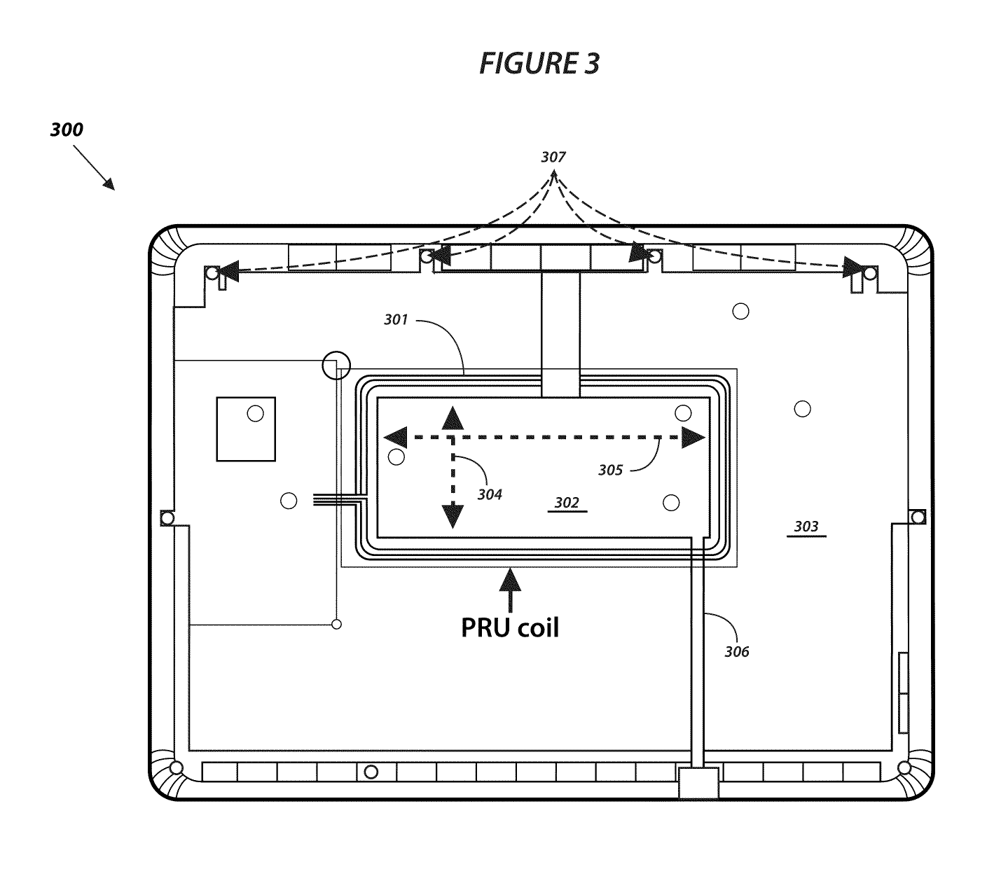

FIG. 3 is a top view of a PRU coil 301 and a conductive surface 303 disposed on a back cover 300 of a computing system consistent with the present disclosure. In the embodiment shown, PRU coil 301 includes a multi-turn coil whereas conductive surface 303 includes a conductive sheet. In some embodiments, conductive surface 303 is highly conductive and is more conductive than the device components within the system base. Conductive surface 300 may include copper (e.g., copper tape or copper sheet) or aluminum. The thickness of conductive surface 300 may be on the order of hundreds of microns in some implementations.

Notably, conductive surface 303 includes an opening 302 (e.g. window) in a center portion therein. It should be understood by one having ordinary skill in the art, however, that the opening 302 does not necessarily have to be in a center portion of the conductive surface 303.

Opening 302 may have a symmetric shape such as a rectangular ring shape but is not limited thereto. For example, opening 302 may have a circular or square shape. Most importantly, opening 302 allows a magnetic field to penetrate through the conductive surface 303. As such, the area of opening 302 affects the magnetic coupling between PRU coil 301 and the PTU device. In some embodiments, the area of opening 302 should be less than the area defined by the most internal turn of PRU coil 301. The area of opening 302 may be adjustable to meet the magnetic coupling requirements between PRU coil 301 and the PTU device.

The dimensions 304, 305 of opening 302 may be approximately, for example, 35 mm×56 mm yielding the mutual impedance (Z) between PRU coil 301 and the PTU device may be approximately 34 ohms in some implementations. The dimensions of other suitable sizes of opening 302 may be 16 mm×56 mm and 56 mm×133 mm which may yield mutual impedances of 30 ohms and 40 ohms, respectively.

In some embodiments, the shape of PRU coil 301 matches (or substantially matches) the shape defined by the perimeter of the opening 302. For example, if the shape of opening 302 is rectangular, the shape of PRU coil 301 is also rectangular. Regardless of the shape of the opening 302, however, the area defined by PRU coil 301 should exceed that of opening 302. For example, in one implementation, the dimensions of opening 302 are 35 mm×56 mm in size and the dimensions of PRU coil 301 is 150 mm×75 mm in size.

In addition to opening 302, conductive surface 303 includes a slot 306 which prevents the conductive surface 303 from completing a ring shape. Advantageously, slot 306 prevents eddy current(s) from forming around the perimeter of opening 302. In some embodiments, slot 306 has dimensions which allow the system base and other components of the device to be shielded by the conductive surface 303 without significantly reducing the magnetic coupling between PRU coil 301 and the PTU device. In some implementations, the area of slot 306 is less than a tenth of the area of conductive surface 303. The width of slot 306 may be in the range of 5-10 mm.

The conductive surface 300 may be grounded to retain ESD protection and EMI shielding of the chassis. For example, grounding points 307 (e.g., screws) may be disposed at strategic locations away from slot 306. In some embodiments, the conductive surface 300 also comprises a material that effectively eliminates unwanted coupling, loss, and interference to system components.

In some implementations, the bottom cover/conductive surface structure may be constructed by modifying a metal chassis via a co-molding technique. For instance, a co-molding technique may modify plastic for the bottom cover and metal for the conductive surface. In some embodiments, when the metal chassis is formed by a co-molding process, the side of the conductive surface 300 with the slot 306 does not have grounding between the metal bottom cover and system ground.

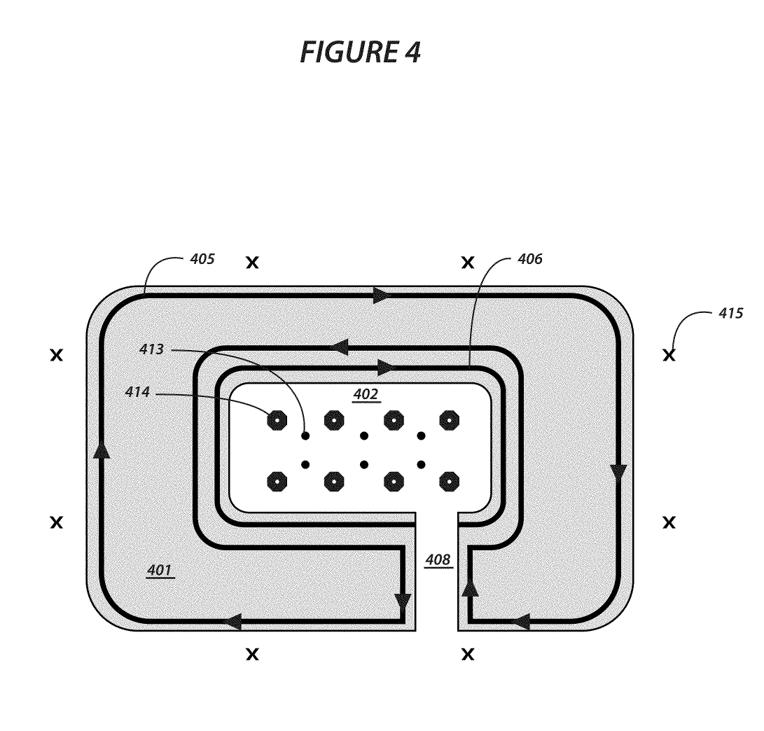

FIG. 4 is an exemplary illustration of a conductive surface 401 within a computing system with eddy current(s) traversing along a perimeter of the conductive surface. Advantageously, the present disclosure allows a magnetic field 413 generated by an external PTU device to penetrate through the conductive surface 401 by disrupting the formation of an eddy current(s) 405 loop around the opening 402 of the conductive surface 401 by the presence of a slot 408.

The eddy current(s) 405 may be generated as a result of the PTU magnetic field 413 coupling to the conductive surface 401. Notably, the direction that the eddy current(s) 405 loops around the opening 402 generates a reactive field 414 that is in phase with magnetic field 413 which in turn enhances the magnetic coupling between the PTU and PRU coil. The resulting field created by the combination of magnetic field 413 and reactive field 414 penetrates through opening 402 to induce a current on the PRU resonator.

Some of the eddy-current reactive field 415 is distributed externally to the conductive surface 401 as the eddy current(s) 405 traverses the perimeter of the conductive surface 401 as shown in FIG. 4. Accordingly, the eddy current(s) 405 can not complete its loop but is instead forced to traverse along the outer edge of the conductive surface 401 thereby enhancing the magnetic field 413 generated by the PRU coil thereby inducing a stronger current 406 on the PRU coil behind the conductive surface 401. Although the conductive surface 401 comprises a single slot 408, the present disclosure anticipates that the conductive surface 401 may include one or more slots 408 therein.

As described above, the magnitude of the magnetic field that penetrates the opening 402 of conductive surface 401 is a function of the dimensions of the opening 402. Likewise, the dimensions of the opening 402 also contributes the amplitude of the resulting eddy current(s) which eventually alters the magnetic coupling between the PRU coil and PTU device. Notably, as the dimensions of opening 402 increases, the resulting mutual impedance (Z) between the PRU coil and PTU device also increases.

Accordingly, the present disclosure employs a unique conductive-surface solution to achieve maximum coupling optimization and flexibility. Moreover, the conductive surface 401 anticipated by the present disclosure also effectively maintains EMI/ESD integrity.

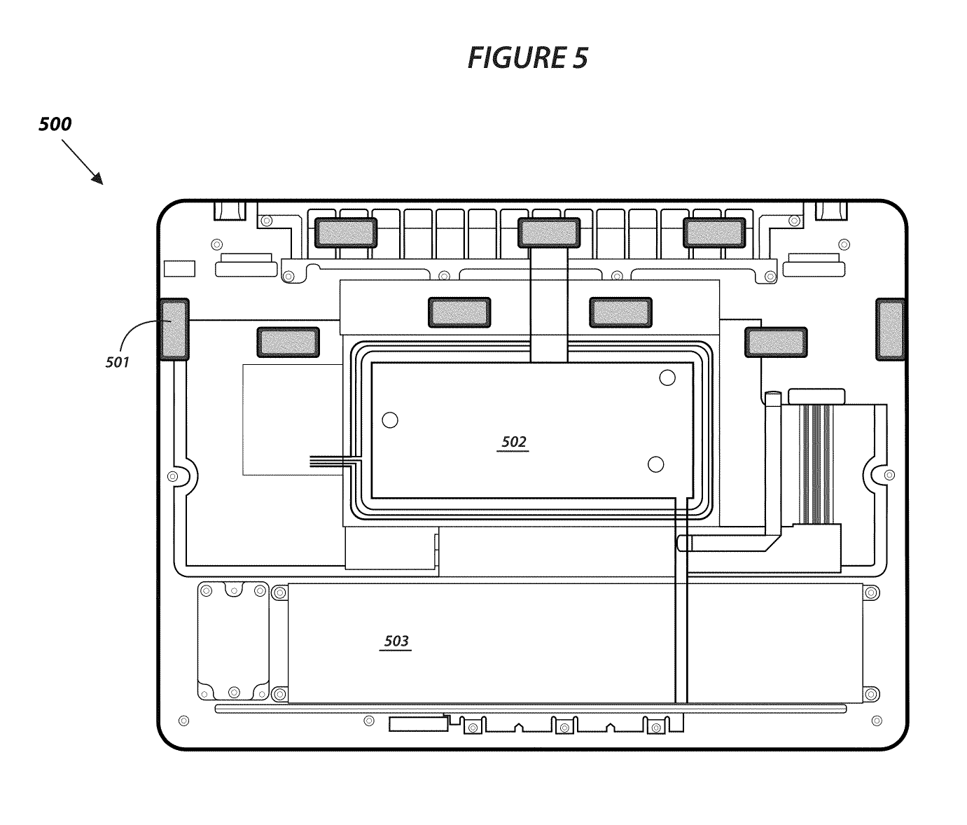

FIG. 5 is an exemplary illustration of a back of a computing system consistent with the present disclosure. As shown, non-conductive back cover 500 features a plurality of EMI gaskets 501 of a Faraday cage, an electromagnetic shield 502, and a non-conductive back cover 503. The present disclosure also anticipates employing a semi-Faraday cage on an external portion of the non-conductive back cover 503.

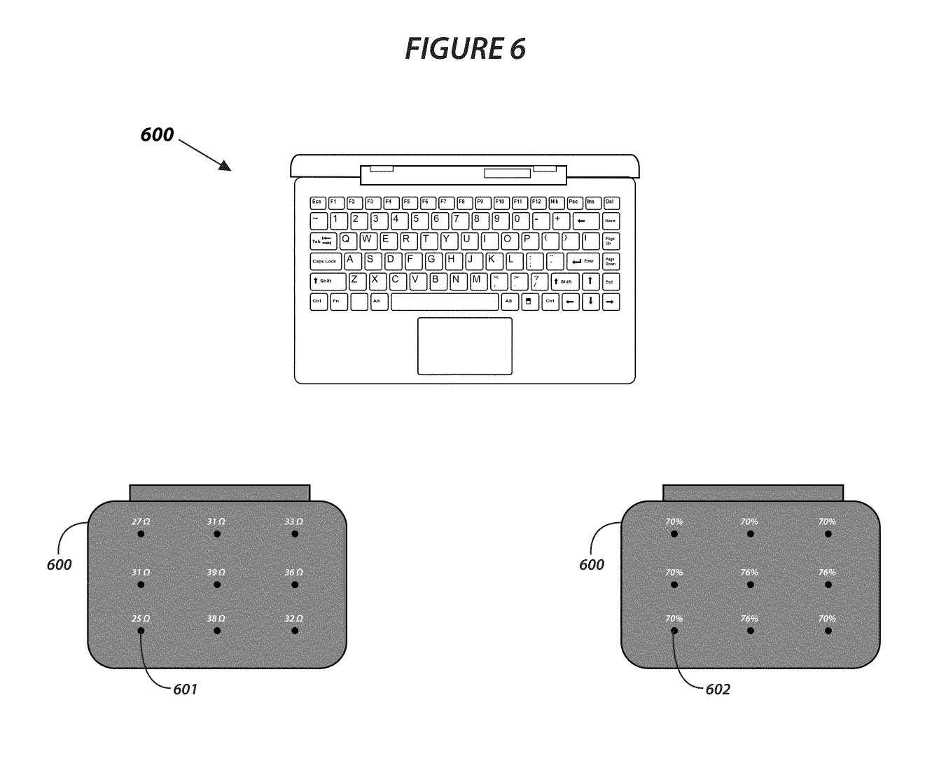

FIG. 6 is an illustration of a top portion of a computing system 600 illustrating a coupling impedance and coupling efficiency profile between power transfer units (PTU) and PRU devices at various locations. Particularly, FIG. 6 illustrates the mutual coupling impedance 601 and coil-to-coil efficiency 602 of a PRU coil (not shown) with an external PTU device (not shown) at distinct locations within a computing system 600.

Advantageously, the disclosed wireless-charging integration solution provides a viable method of integrating wireless charging PRU devices into mobile platforms without significantly impacting the wireless charging performance and system EMI/ESD integrity. The solution employs a novel conductive surface which increases the coil-to-coil (from PTU and PRU devices) efficiency to approximately 80%. In the embodiment shown, the mutual coupling impedance 601 and coil-to-coil efficiency 602 are shown at nine distinct locations. As shown, the mutual coupling impedance 601 is in the range of 25 to 39 ohms and the coil-to-coil efficiency 602 is in the range of 70% to 76%.

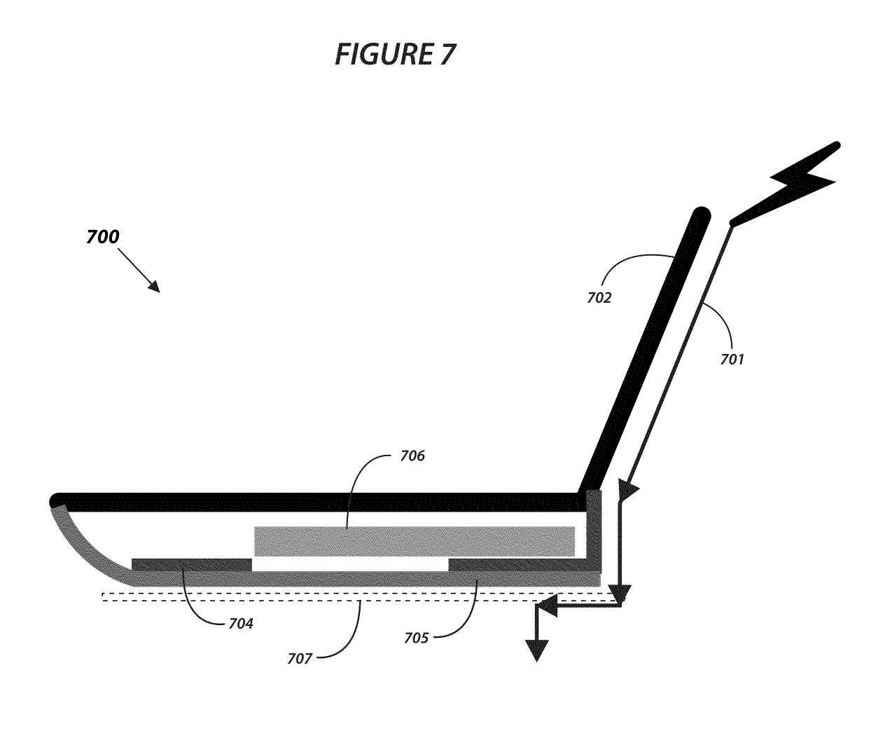

FIG. 7 illustrates the routing 701 of electrostatic noise to ground within a computing system 700 having an internal PRU/conductive surface unit. As illustrated, ESD noise (which may be generated from a user's handling of the monitor 702) is routed 701 to grounding points beneath the computing system 700 via a conductive path created by a conductive surface 704, 705 disposed on the inside surface of the device's 700 back cover.

Accordingly, the wireless charging solution described herein significantly reduces the degree of ESD from passing through the motherboard 706 and other critical components within the computing system 700. During operation, a PTU 707 can efficiently transfer power to the computing system 700 without exposing system components to significant ESD/EMI effects.

Additionally, the PRU coil integration technique described herein enables OEMs to integrate wireless charging solutions that meet the wireless charging, EMI/ESD, and mechanical requirements. In addition, the wireless charging solution also separates the tuning of coil-to-coil coupling from coil designs which essentially allows unified modular PTU and PRU modules to be developed and implemented.

The Following Examples Pertain to Further Embodiments

Example 1 is an apparatus. The apparatus includes a computing unit which includes a system base, conductive surface, and power receiving unit. In some embodiments, the conductive surface has an opening that is adjacent to the power receiving unit and a slot extending from the opening towards the perimeter of the conductive surface. The system base may be coupled to the power receiving unit. The power receiving unit is to provide power to the system base.

In Example 2, the power receiving unit includes a magnetic coil. In Example 3, the opening of the conductive surface has at least one of a circular, square, or rectangular shape. In Example 4, the computing unit comprises a non-conductive bottom cover which is adjacent to the conductive surface. In Example 5, the system base includes at least one input device. In Example 6, the apparatus is an ultrabook computer. In Example 7, the conductive surface includes a conductive sheet.

Example 8 includes a computing system. The computing system includes a non-conductive bottom cover, conductive sheet, power receiving unit, electromagnetic shield, and system base. In some embodiments, the conductive sheet has an opening. The conductive sheet may be adjacent to the non-conductive bottom cover. Further, the conductive sheet may include a slot extending from the opening towards the perimeter of the conductive sheet. In some embodiments, the power receiving unit is adjacent to the conductive sheet and disposed around the perimeter of the opening. In the example, the electromagnetic shield is adjacent to the power receiving unit and covers the opening of the conductive sheet. The system base may be adjacent to the electromagnetic shield.

In Example 9, the conductive sheet includes at least one of aluminum or copper. In Example 10, the dimensions of the opening are on the order of millimeters. In Example 11, the electromagnetic shield includes ferrite. In Example 12, the system base includes at least one of a keyboard, touchpad, Ethernet port, display port, microphone-in jack, speaker line-out jack, or battery.

In Example 13, the power receiving unit includes a magnetic coil. In Example 14, the magnetic coil is disposed around the perimeter of the opening in a rectangular shape. In Example 15, the conductive sheet is adjustable to change the size of an internal area of the opening.

Example 16 includes a conductive sheet. The conductive sheet of Example 16 includes a conductive surface having an opening and a slot extending therethrough. The conductive surface includes an opening therein. The slot extends from the opening towards the perimeter of the conductive surface. In some embodiments, the conductive surface shields electromagnetic interference and provides electrostatic discharge protection.

In Example 17, the area of the slot is less than a tenth of the area of the conductive surface. In Example 18, the conductive surface includes at least one of a copper sheet, copper tape, aluminum sheet, or aluminum tape. In Example 19, the conductive sheet further includes a plurality of grounding points disposed on the conductive surface.

Example 20 is a system. The system of Example 20 includes a computing unit and a power transmitting unit adjacent thereto. The computing unit includes a system base, conductive surface, and power receiving unit. The conductive surface includes an opening that is adjacent to the power receiving unit and a slot extending from the opening towards the perimeter of the conductive surface. The system base may be coupled to the power receiving unit. The power unit is to provide power to the system base.

In Example 21, the computing unit is at least one of a smartphone device, computing tablet, notebook computer, sub-notebook computer, ultraportable notebook computer, mini-notebook computer, netbook computer, ultrabook computer, or laptop computer.

Example 22 is a system. The system of Example 22 includes a computing unit and a power transmitting unit adjacent thereto. The computing unit includes a power receiving unit, conductive surface, and system base. The conductive surface includes an opening that is adjacent to the power receiving unit and a slot extending from the opening towards the perimeter of the conductive surface. The system base may be coupled to the power receiving unit and provides power thereto.

Example 23 is a computing system. The computing system of Example 23 includes a conductive bottom cover, power receiving unit, electromagnetic shield, and system base. The conductive bottom cover includes an opening filled with a non-conductive material. The conductive bottom cover includes a slot, filled with non-conductive material, extending from the opening towards the perimeter of the conductive bottom cover. The power receiving unit may be adjacent to the conductive bottom cover and may be disposed around the perimeter of the opening. The electromagnetic shield may be adjacent to the power receiving unit and may cover the opening of the conductive bottom cover. The system base may be adjacent to the electromagnetic shield.

In Example 24, the conductive bottom cover includes copper, aluminum, magnesium, metal alloys, and carbon fiber. In Example 25, the electromagnetic shield includes ferrite. In Example 26, the system base includes at least one of a keyboard, touchpad, Ethernet port, display port, microphone-in jack, speaker line-out jack, or battery. In Example 27, the power receiving unit includes a magnetic coil. In Example 28, the magnetic coil is disposed around the perimeter of the opening in a rectangular shape. In the Example 29, the conductive bottom cover is adjustable to change the internal area of the opening. In Example 30, the dimensions of the openings are on the order of millimeters.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, numerous foregoing uses of “embodiment,” “example,” or similar terms may refer either to a single embodiment or to different and distinct embodiments.

The preceding description and accompanying drawings describe example embodiments in some detail to aid understanding. However, the scope of the claims may cover equivalents, permutations, and combinations that are not explicitly described herein.

What is claimed is:

1. An apparatus, comprising:
a computing unit, comprising:
a power receiving unit;
a conductive surface having an opening that is adjacent to the power receiving unit and a slot extending from the opening towards the perimeter of the conductive surface; and
a system base coupled to the power receiving unit wherein the power receiving unit is to provide power to the system base.

2. The apparatus of claim 1, wherein the power receiving unit includes a magnetic coil.

3. The apparatus of claim 1, wherein the opening of the conductive surface has at least one of a square, rectangular, or circular shape.

4. The apparatus of claim 1, wherein the computing unit comprises a non-conductive bottom cover which is adjacent to the conductive surface.

5. The apparatus of claim 1, wherein the system base includes at least one input device.

6. The apparatus of claim 1, wherein the apparatus is an ultrabook computer.

7. The apparatus of claim 1, wherein the conductive surface includes a conductive sheet.

8. A computing system, comprising:
a non-conductive bottom cover;
a conductive sheet, having an opening, adjacent to the non-conductive bottom cover and a slot extending from the opening towards the perimeter of the conductive sheet;
a power receiving unit adjacent to the conductive sheet and disposed around the perimeter of the opening;
an electromagnetic shield adjacent to the power receiving unit and covering the opening of the conductive sheet; and
a system base adjacent to the electromagnetic shield.

9. The computing system of claim 8, wherein the conductive bottom cover comprises at least one of aluminum or copper.

10. The computing system of claim 8, wherein the dimensions of the opening are on the order of millimeters.

11. The computing system of claim 8, wherein the electromagnetic shield includes ferrite.

12. The computing system of claim 8, wherein the system base includes at least one of a keyboard, touchpad, Ethernet port, display port, microphone-in jack, speaker line-out jack, or battery.

13. The computing system of claim 8, wherein the power receiving unit includes a magnetic coil.

14. The computing system of claim 13, wherein the magnetic coil is disposed around the perimeter of the opening in a rectangular shape.

15. The computing system of claim 13, wherein the conductive sheet is adjustable to change the size of an internal area of the opening.

16. A back cover of a computing device, comprising:
a conductive surface having an opening therein; and
a slot extending from the opening towards the perimeter of the conductive surface;
wherein the conductive surface is to shield electromagnetic interference and to provide electrostatic discharge protection.

17. The conductive sheet of claim 16, wherein the area of the slot is less than a tenth of the area of the area of the conductive surface.

18. The conductive sheet of claim 16, wherein the conductive surface comprises at least one of copper sheet, copper tape, aluminum sheet, or aluminum tape.

19. The conductive sheet of claim 16 further comprising a plurality of grounding points disposed on the conductive surface.

20. A system, comprising:
a computing unit, comprising:
a power receiving unit;
a conductive surface having an opening that is adjacent to the power receiving unit and a slot extending from the opening towards the perimeter of the conductive surface; and
a system base coupled to the power receiving unit wherein the power receiving unit is to provide power to the system base; and
a power transmitting unit adjacent to the computing unit.

21. The system of claim 20, wherein the computing unit is at least one of a smartphone device, computing tablet, notebook computer, sub-notebook computer, ultraportable notebook computer, mini-notebook computer, netbook computer, ultrabook computer, or laptop computer.

22. The system of claim 20 further comprising a faraday cage disposed between the system base and the conductive surface.

23. A computing system, comprising:
a conductive bottom cover having an opening filled with non-conductive material;
a slot, filled with non-conductive material, extending from the opening towards the perimeter of the conductive bottom cover;
a power receiving unit adjacent to the conductive bottom cover and disposed around the perimeter of the opening;
an electromagnetic shield adjacent to the power receiving unit and covering the opening of the conductive bottom cover; and
a system base adjacent to the electromagnetic shield.

24. The computing system of claim 23, wherein the conductive bottom cover comprises at least one of carbon fiber, aluminum, magnesium, copper, or metal alloys.

25. The computing system of claim 23, wherein the electromagnetic shield includes ferrite.

26. The computing system of claim 23, wherein the system base includes at least one of a keyboard, touchpad, Ethernet port, display port, microphone-in jack, speaker line-out jack, or battery.

27. The computing system of claim 23, wherein the power receiving unit includes a magnetic coil.

28. The computing system of claim 27, wherein the magnetic coil is disposed around the perimeter of the opening in a rectangular shape.

29. The computing system of claim 27, wherein the conductive bottom cover is adjustable to change the internal area of the opening.

30. The computing system of claim 23, wherein the dimensions of the opening are on the order of millimeters.
